(19) United States
(12) Patent Application Publication
(10) Pub. No.: US 2020/0104340 A1
(43) Pub. Date: Apr. 2, 2020

(54) A/B TESTING USING QUANTILE METRICS

(71) Applicant: Microsoft Technology Licensing, LLC, Redmond, WA (US)

(72) Inventors: Min Liu, Palo Alto, CA (US); Xiaohui Sun, Palo Alto, CA (US); Maneesh Varshney, San Jose, CA (US); Ya Xu, Los Altos, CA (US)

(73) Assignee: Microsoft Technology Licensing, LLC, Redmond, WA (US)

(21) Appl. No.: 16/146,699

(22) Filed: Sep. 28, 2018

(51) Int. Cl. G06F 17/18; G06F 9/48; G06F 17/30; G06Q 30/02

(52) U.S. Cl. CPC G06F 17/18; G06F 9/4812; G06Q 30/0201; G06F 17/30864; G06F 17/30489; G06F 17/30469

(57) ABSTRACT

The disclosed embodiments provide a system for performing A/B testing using quantile metrics. During operation, the system obtains metrics collected during an A/B test. Next, the system calculates an asymptotic estimate of a variance of a quantile for the metrics based on a lack of statistical independence of the metrics from one another. The system then determines a statistical significance of a result of the A/B test based on the asymptotic estimate of the variance. Finally, the system outputs the statistical significance with the result for use in assessing an effect of a treatment variant of the A/B test on the quantile.

### BACKGROUND

The disclosed embodiments relate to A/B testing. More specifically, the disclosed embodiments relate to techniques for performing A/B testing using quantile metrics.

### RELATED ART

A/B testing, or controlled experimentation, is a standard way to evaluate user engagement or satisfaction with a new service, feature, or product. For example, a company may use an A/B test to show two versions of a web page, email, article, social media post, layout, design, and/or other information or content to users to determine if one version has a higher conversion rate than the other. If results from the A/B test show that a new treatment version performs better than an old control version by a certain amount, the test results may be considered statistically significant, and the new version may be used in subsequent communications or interactions with users already exposed to the treatment version and/or additional users.

A/B tests are typically used to compare average values of metrics between treatment and control versions. For example, an A/B test may be used to determine if a treatment version of a feature increases and/or improves view rate, session length, number of sessions, and/or other performance metrics related to user interaction with the feature over a corresponding control version of the feature.

On the other hand, user experiences and/or outcomes are frequently impacted by non-average performances. For example, all pages in a website load in roughly 0.5 seconds. Alternatively, 10% of web pages in the website may have a 5-second page load, and the remaining 90% of web pages may have a much faster page load time. While both distributions of page load times may have roughly the same average page load time of 0.5 seconds, the 5-second page load times in the second distribution may result in user perceptions of the website as being very slow, while the 0.5-second page load times in the first distribution may result in user perceptions of the website as being fast.

Consequently, A/B testing techniques and/or results may be improved by comparing non-average performance between treatment and control versions in A/B tests.

### BRIEF DESCRIPTION OF THE FIGURES

FIG. 1 shows a schematic of a system in accordance with the disclosed embodiments.

FIG. 2 shows a system for performing A/B testing using quantile metrics in accordance with the disclosed embodiments.

FIG. 3 shows a flowchart illustrating a process of performing A/B testing using quantile metrics in accordance with the disclosed embodiments.

FIG. 4 shows a flowchart illustrating a process of estimating a variance of a quantile in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### OVERVIEW

The disclosed embodiments provide a method, apparatus, and system for performing A/B testing. During an A/B test, one set of users may be assigned to a treatment group that is exposed to a treatment variant, and another set of users may be assigned to a control group that is exposed to a control variant. The users' responses to the exposed variants may then be monitored and used to determine if the treatment variant performs better than the control variant.

More specifically, the disclosed embodiments provide a method, apparatus, and system for performing A/B testing using quantile metrics. The quantile metrics may include percentiles of interest in performance metrics that are collected during A/B tests. For example, an A/B test may be used to compare 90^{th} percentile page load times for treatment and control versions of one or more web pages, which may impact user experiences and/or outcomes more than average or 50^{th} percentile page load times.

During A/B testing of a quantile metric, a variance of the quantile metric may be required to calculate a p-value, margin of error, and/or indicator of the statistical significance of A/B testing results. As a result, the statistical validity of the variance calculation may directly affect the outcome of an A/B test. The variance calculation may additionally be required to scale with multiple concurrent A/B tests and/or A/B tests with large numbers of users (e.g. thousands to millions) on an A/B testing platform.

To calculate variances of quantiles in a scalable, statistically valid way, the disclosed embodiments may generate asymptotic estimates of the variances based on an assumption that the metrics from which the quantiles are calculated are not statistically independent from one another. For example, an estimate of the variance of a 90^{th} percentile page load time may be calculated based on the assumption that page load times from the same user are not statistically independent (e.g., because the page load times may be affected by the user's network bandwidth and/or connection speed), while page load times from different users are statistically independent.

An asymptotic estimate of a quantile's variance may be produced by calculating an additional variance of a joint distribution of the corresponding counts of metrics and counts of the metrics that are below the quantile, estimating a density of the metrics around the quantile, and combining the additional variance and the density of the metric into the estimate. Calculation of the asymptotic estimate may further be improved by compressing dimensions, treatment assignments, user identifiers, user segments targeted by the corresponding A/B tests, and/or other attributes associated with performance metrics collected during the A/B tests; aggregating the performance metrics into histograms for different combinations of attributes; and using the histograms to estimate the variance.

Because relatively straightforward calculations are used to accurately estimate the variance of a quantile metric, the disclosed embodiments may allow large-scale A/B testing to be performed using quantile metrics. In contrast, conventional techniques for calculating quantile variances may include asymptotic estimates that inaccurately assume statistical independence of the corresponding metrics and/or less scalable bootstrap techniques that repeatedly sample from observed data and calculate variances from each resample. Consequently, the disclosed embodiments may improve computer systems and/or technologies for performing A/B testing, monitoring performance metrics, and/or estimating variances for quantile metrics.

### A/B Testing Using Ouantile Metrics

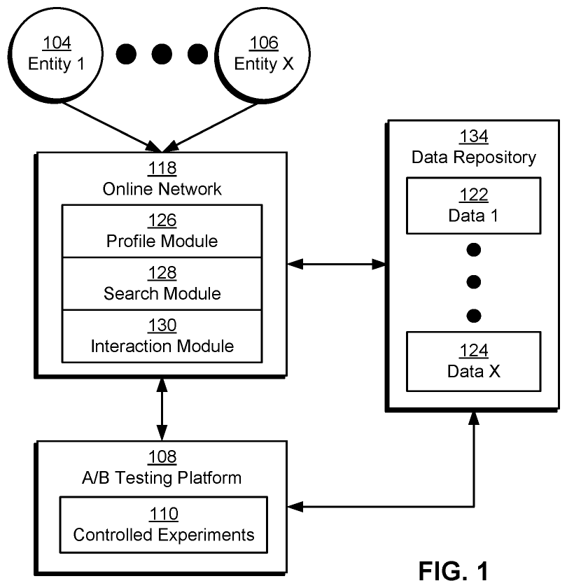

FIG. 1 shows a schematic of a system in accordance with the disclosed embodiments. As shown in FIG. 1, the system may include an online network 118 and/or other user community. For example, online network 118 may include an online professional network that is used by a set of entities (e.g., entity 1 104, entity x 106) to interact with one another in a professional and/or business context.

The entities may include users that use online network 118 to establish and maintain professional connections, list work and community experience, endorse and/or recommend one another, search and apply for jobs, and/or perform other actions. The entities may also include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 may be tracked and stored in a database, data warehouse, cloud storage, and/or other data-storage mechanism providing data repository 134.

In turn, data in data repository 134 may be used by an A/B testing platform 108 to conduct controlled experiments 110 of features in online network 118. Controlled experiments 110 may include A/B tests that expose a subset of the entities to a treatment variant of a message, feature, and/or content. For example, A/B testing platform 108 may select a random percentage of users for exposure to a new treatment variant of an email, social media post, feature, offer, user flow, article, advertisement, layout, design, and/or other content during an A/B test. Other users in online network 118 may be exposed to an older control variant of the content.

During an A/B test, entities affected by the A/B test may be exposed to the treatment or control variant, and the entities' responses to or interactions with the exposed variants may be monitored. For example, entities in the treatment group may be shown the treatment variant of a feature after logging into online network 118, and entities in the control group may be shown the control variant of the feature after logging into online network 118. Responses to the control or treatment variants may be collected as clicks, views, searches, user sessions, conversions, purchases, comments, new connections, likes, shares, and/or other performance metrics representing implicit or explicit feedback from the entities. The metrics may be aggregated into data repository 134 and/or another data-storage mechanism on a real-time or near-real-time basis and used by A/B testing platform 108 to compare the performance of the treatment and control variants.

Those skilled in the art will appreciate that conventional A/B testing techniques may compare average values of performance metrics related to the treatment and control variants. For example, an A/B test may compare the treatment and control versions of a feature, message, and/or content using average click-through rates (CTRs), view rates, session length, number of sessions, log-in rates, job application rates, job search rates, page load times, and/or other metrics related to user interaction with the treatment and control versions.

On the other hand, user experiences and/or outcomes are frequently impacted by non-average performances. For example, a 0.5-second average page load time for a website may be distributed roughly uniformly across all web pages in the website, or may be concentrated in a 5-second page load time for 10% of web pages in the website and a much faster page load time for remaining web pages in the website. Despite the same average page load time in both instances, the 5-second page load time in the second distribution may result in user perceptions of the website as being very slow, while the 0.5-second page load times in the first distribution may result in user perceptions of the website as being relatively fast.

In one or more embodiments, A/B testing platform 108 includes functionality to perform A/B testing using quantile metrics associated with controlled experiments 110, in lieu of or in addition to A/B testing of averages and/or other aggregations of performance metrics associated with controlled experiments 110. For example, A/B testing platform 108 may be used to compare the 90^{th} percentile page load times for treatment and control variants of one or more web pages used to access online network 118. As discussed in further detail below, such quantile-based A/B testing may utilize quantile variance estimates that are statistically valid and scalable, thereby allowing quantiles to be compared using A/B tests on A/B testing platform 108 independently of the number of concurrent A/B tests running on A/B testing platform 108 and/or the number of users in each A/B test.

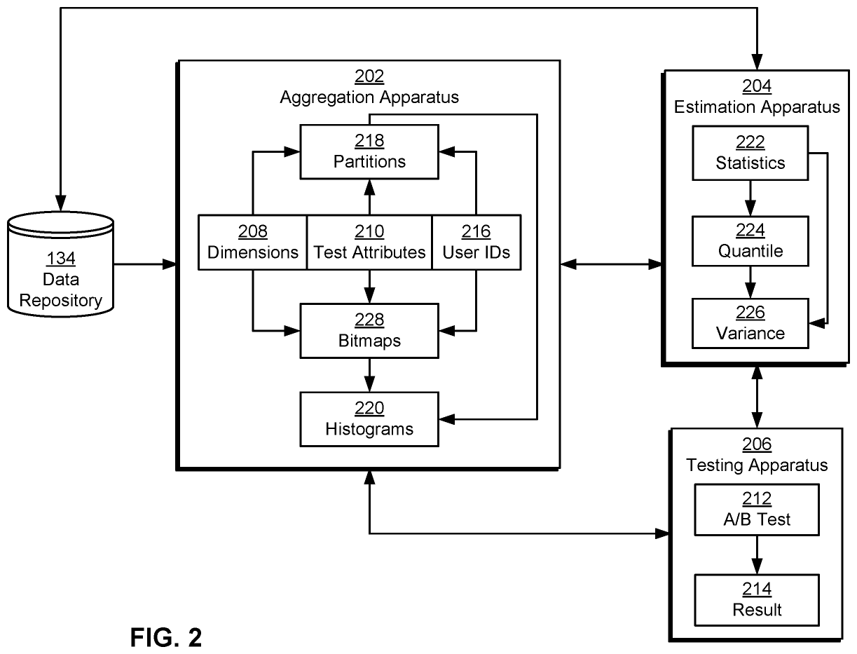

FIG. 2 shows a system for performing A/B testing (e.g., A/B testing platform 108 of FIG. 1) using quantile metrics in accordance with the disclosed embodiments. The system of FIG. 2 includes an aggregation apparatus 202, and estimation apparatus 204, and a testing apparatus 206. Each of these components is described in further detail below.

Aggregation apparatus 202 aggregates metrics collected during an A/B test 212. For example, the metrics may include page views, page load times, latencies, error rates, session counts, session lengths, CTRs, conversion rates, and/or other performance metrics that are used to compare the treatment and control variants of A/B test 212.

As shown in FIG. 2, the metrics may be obtained from data repository 134. For example, data repository 134 may include records of page views by users of an application and/or website, such as online network 118 of FIG. 1. Each record may include a user identifier (ID) of a user (e.g., user IDs 216), a page ID of a page view by the user, a product accessed using the page view (e.g., homepage, profile module, jobs module, content feed, and/or another portion or feature of the online network), a timestamp for the page view, and/or a page load time of the page view.

Data repository 134 may also include dimensions 208, test attributes 210, and/or other attributes by which the metrics are aggregated. First, data repository 134 may include records of treatment assignments in A/B test 212, with each record containing a user ID, a test key for A/B test 212, a treatment assignment of the user to a treatment group or control group in A/B test 212, and/or other test attributes 210 related to A/B test 212.

Second, data repository 134 may include records of user data for the users, with each record containing the corresponding user's name, email address, physical address, profile picture, and/or other personally identifying information. Each record of user data may additionally include dimensions 208 related to the user, such as the user's country, language, industry, seniority, job title, school, group memberships, and/or type of account (e.g., free, paid, premium, etc.).

Dimensions 208 may be used to define segments by which users are targeted using A/B test 212. For example, a configuration for A/B test 212 may specify one or more segments of users for inclusion in A/B test 212. Each segment may include attributes of the corresponding users, such as the users' locations, industries, companies, seniorities, languages, and/or user identifiers. The attributes may also indicate the presence or absence of profile pictures, summaries, endorsements, and/or other fields in the users' profiles (e.g., with an online network and/or website). Within each segment, the configuration may specify a distribution of treatment assignments in A/B test 212 (e.g., 50% treatment and 50% control, 10% treatment and 90% control, 100% treatment, etc.).

More specifically, aggregation apparatus 202 aggregates metrics associated with A/B test 212 under treatment and control groups in A/B test 212 to enable subsequent comparison of the metrics between the treatment and control groups by A/B test 212. For example, aggregation apparatus 202 may use user IDs 216 as join keys to join records of page load times experienced by the users with records of treatment assignments of the users to the treatment and control groups of A/B test 212.

Those skilled in the art will appreciate that large numbers of records may be used to store metrics, treatment assignments, and/or other data that is aggregated by aggregation apparatus 202. For example, A/B test 212 may involve large numbers (e.g., thousands to millions) of metrics, treatment assignments, and/or other types of data. Moreover, the data may include multiple one-to-many mappings, such as mappings of one user to multiple page views of different pages and/or mappings of one user to treatment assignments in multiple A/B tests. In turn, joining of records containing multiple one-to-many mappings may cause the number of records to “explode” (e.g., joining m treatment assignments with n page views produces m x n joined records).

In one or more embodiments, aggregation apparatus 202 uses a number of techniques to reduce overhead associated with aggregating and/or joining metrics and/or other data associated with A/B test 212. First, aggregation apparatus 202 divides records containing the metrics, dimensions 208, test attributes 210, and/or user IDs 216 into a number of partitions 218. For example, aggregation apparatus 202 may distribute records containing the metrics, dimensions 208, test attributes 210, and/or user IDs 216 across multiple partitions 218 based on user IDs 216 (e.g., by assigning a record to a partition based on a hash of the corresponding user ID). As a result, all records containing the user ID may be found in the same partition, independently of the data stored in the records (e.g., dimensions 208, test attributes 208, metrics, etc.).

Next, aggregation apparatus 202 generates bitmaps 228 associated with dimensions 208, test attributes 210, and/or user IDs 216 to compress data associated with A/B test 212. For example, aggregation apparatus 202 may populate a hash table in each partition with representations of dimensions 208, test attributes 210, and user IDs 216 associated with A/B test 212. Keys to the hash table may include different combinations of test attributes 210 (e.g., test keys, treatment assignments, etc.) and/or dimensions 208 (e.g., user countries, languages, industries, etc.) to be analyzed using A/B test 212. Each key may map to a hash bucket containing a bitmap that encodes user IDs 216 of all users that have the corresponding attributes (e.g., users that have the same treatment assignment in a given A/B test, users that are from the same country and have the same treatment assignment in an A/B test, etc.).

Aggregation apparatus 202 then uses bitmaps 228 and/or the corresponding hash tables to efficiently join and/or aggregate records containing the metrics into a number of histograms 220. For example, aggregation apparatus 202 may iterate through records containing user IDs 216, page load times experienced by the users, and/or page IDs and/or products associated with the page load times. As mentioned above, the records may be distributed across partitions by user IDs 216.

For each record, aggregation apparatus 202 may search a hash table in the same partition for all combinations of test attributes 210 and/or dimensions 208 that map to bitmaps containing the user ID in the record. Aggregation apparatus 202 may then store the page load time from the record in the corresponding bucket (e.g., a bucket of page load times into which the page load time falls) of a histogram of page load times for each identified combination of test attributes 210 and/or dimensions 208. Thus, if the user ID is matched to bitmaps for three different combinations of A/B test, treatment assignment, and/or user country, aggregation apparatus 202 may update three histograms with the page load time. Each histogram may be identified by the corresponding A/B test, treatment assignment, and/or user country, as well as a product or page ID by which page load times are aggregated. Consequently, aggregation apparatus 202 may generate a separate histogram of aggregated metrics for each combination of test attributes 210 and/or dimensions 208 for which one or more quantile metrics are to be calculated.

After histograms 220 are generated for all partitions 218 and/or from all records of metrics in each partition, estimation apparatus 204 uses some or all histograms 220 to estimate a variance 226 of a quantile 224 of a metric. First, estimation apparatus 204 may calculate a set of statistics 222 from each histogram and/or an aggregated version of all histograms 220. Next, estimation apparatus 204 aggregates statistics 222 across partitions 218 and/or uses statistics 222 to calculate quantile 224. Estimation apparatus 204 then uses statistics 222 and quantile 224 to estimate variance 226.

In one or more embodiments, estimation apparatus 204 calculates an asymptotic estimate of variance 226 based on an assumption that the metrics from which quantile 224 is calculated are not statistically independent from one another. For example, estimation apparatus 204 may estimate variance 226 of a 90^{th} percentile page load time under the assumption that page load times from the same user are not statistically independent from one another, while page load times from different users are statistically independent from one another.

A derivation of the asymptotic estimate of variance 226 based on an assumption of non-independence among the corresponding metrics may be performed using an example distribution F of page load times Xᵢⱼ, where i represents a user and j represents a page view of user i. The following functions are defined using Xᵢⱼ:

$${Y}^{( n )} ( x ) = \frac{1}{n} {\sum }_{i}^{n} {\sum }_{j}^{{P}_{i}} {I}_{( {X}_{i , j} \leq x )} = \frac{1}{n} {\sum }_{i}^{n} {J}_{i} , \\ where$$

$${J}_{i} = {\sum }_{j = 1}^{{P}_{i}} {I}_{\{ {X}_{i , j} \leq x \}}$$

Jᵢ is a summation across all page views Pᵢ of user i of an indicator function that is set to 1 when a page load time is less than or equal to a threshold x and to 0 when the page load time is greater than the threshold x. As a result, Jᵢ may be a count of the user's page load times that meet the threshold. Y⁽ⁿ⁾(x) may be a summation of values of Jᵢ across all n users divided by n. Thus, Y⁽ⁿ⁾(x) may represent the average number of page views that meet the threshold across all users.

An additional function is defined using Pᵢ, which represents the total number of page views for user i:

$${P}^{( n )} = \frac{1}{n} {\sum }_{i = 1}^{n} {P}_{i}$$

Consequently, P⁽ⁿ⁾ may represent the average number of page views across all users over the duration of an A/B test (e.g., A/B test 212).

Under the central limit theorem, the joint distribution of Y⁽ⁿ⁾(x) and P⁽ⁿ⁾ may be approximated by a normal distribution with covariance matrix Σ:

$$\sqrt{n} ( ( \begin{matrix}{Y}^{( n )} ( x ) \\ {P}^{( n )}\end{matrix} ) - ( \begin{matrix}{μ}_{j} \\ {μ}^{P}\end{matrix} ) ) -> N ( 0 , \sum )$$

In the above expression, μ_{J} and μ_{P} represent the expected values of Y⁽ⁿ⁾(x) and P⁽ⁿ⁾, respectively. In addition:

$${μ}_{J} = E ( {\sum }_{j = 1}^{{P}_{t}} {I}_{\{ {X}_{i , j} \leq X \}} ) = E [ E ( {\sum }_{j = 1}^{{P}_{i}} {I}_{\{ {X}_{i , j} \leq x \}} \vert {P}_{i} ) ] = {μ}_{P} F ( x ) ,$$

where E denotes expected value and F(x) is the cumulative distribution function of F.

The delta method is then used to obtain the following:

$$\sqrt{n} ( \frac{{Y}^{( n )} ( x )}{{P}^{( x )}} - \frac{{μ}_{J}}{{μ}_{P}} ) -> N ( 0 , {σ}_{P , {J}^{2}} )$$

$${σ}_{P , J}^{2} = {( \frac{{μ}^{J}}{{μ}^{P}} )}^{2} ( \frac{{\sum }^{JJ}}{{( {μ}^{J} )}^{2}} + \frac{{\sum }^{PP}}{{( {μ}^{P} )}^{2}} - 2 \frac{{\sum }^{PJ}}{{μ}^{J} {μ}^{P}} )$$

In the above expressions, σ_{P,J}² represents the variance of the joint distribution of Y⁽ⁿ⁾(x) and P⁽ⁿ⁾, Σ^{JJ} represents the variance of Y⁽ⁿ⁾(x), Σ^{PP} represents the variance of P⁽ⁿ⁾, and Σ^{PJ} represents the covariance of Y⁽ⁿ⁾(x) and P⁽ⁿ⁾.

The above expression may be rewritten as:

$$\sqrt{n} ( {F}_{n} ( x ) - F ( x ) ) -> N ( 0 , {σ}_{P , J}^{2} ) , where {F}_{n} ( x ) = \frac{{Y}^{( n )} ( x )}{{P}^{( n )}}$$

When x=\hat{Q}, which is the sampled value of quantile 224 Q for the A/B test:

\sqrt{n}(Fₙ(\hat{Q})−\hat{Q})→N(0,σ_{P,J}²)

Moreover, since \hat{Q} is a consistent estimate of Q:

\sqrt{n}(q−F(\hat{Q}))→N(0,σ_{P,J}²)

where q denotes the quantile rank of Q.

The delta method is applied again to obtain the following:

$$\sqrt{n} ( {F}^{- 1} ( q ) - \hat{Q} ) -> N ( 0 , \frac{{σ}_{P , J}^{2}}{{{f}_{X} ( Q )}^{2}} )$$

In the above expression, F¹(q)=Q represents the inverse function of F(q). Since the standardized normal distribution is symmetric:

$$\sqrt{n} ( \hat{Q} - Q ) -> N ( 0 , \frac{{σ}_{PJ}^{2}}{{{f}_{X} ( Q )}^{2}} )$$

Consequently, the asymptotic estimate of variance 226 of quantile 224 Q may be calculated as:

$$\frac{{σ}_{PJ}^{2}}{{{nf}_{X} ( Q )}^{2}}$$

In the above expression, fₓ(Q) represents the probability density function of distribution F.

To expedite estimation of variance 226, zero-valued metrics may be excluded from aggregation by aggregation apparatus 202 and/or subsequent calculation of the estimation of variance 226 without affecting the estimated value. Such calculation of variance 226 without zero-valued metrics may be based on the following derivation, in which no represents the number of users with non-zero page views out of n total users:

$${μ}_{J} = \frac{{n}_{0}}{n} {μ}_{J 0} , \\ {μ}_{P} = \frac{{n}_{0}}{n} {μ}_{P 0} , \\ {\sum }^{JJ} = \frac{{n}_{0}}{n} {\sum }_{0}^{JJ} + \frac{{n}_{0}}{n} ( 1 - \frac{{n}_{0}}{n} ) {μ}_{J 0}^{2} , \\ {\sum }^{PP} = \frac{{n}_{0}}{n} {\sum }_{0}^{PP} + \frac{{n}_{0}}{n} ( 1 - \frac{{n}_{0}}{n} ) {μ}_{P 0}^{2} , \\ {\sum }^{JP} = \frac{{n}_{0}}{n} {\sum }_{0}^{JP} + \frac{{n}_{0}}{n} ( 1 - \frac{{n}_{0}}{n} ) {μ}_{J 0} {μ}_{P 0} . \\ \frac{1}{n} {σ}_{P , J}^{2} = \frac{1}{n} {( \frac{{μ}^{J}}{{μ}^{P}} )}^{2} ( \frac{{\sum }^{JJ}}{{μ}^{{J}^{2}}} + \frac{{\sum }^{PP}}{{μ}^{{P}^{2}}} - 2 \frac{{\sum }^{PJ}}{{μ}^{J} {μ}^{P}} ) = \frac{1}{n} {( \frac{{μ}_{0}^{J}}{{μ}_{0}^{P}} )}^{2} ( \frac{{\sum }_{0}^{JJ}}{\frac{{n}_{0}}{n} {μ}_{0}^{P}} + \frac{1 - \frac{{n}_{0}}{n}}{\frac{{n}_{0}}{n}} + \frac{{\sum }_{0}^{PP}}{\frac{{n}_{0}}{n} {μ}_{0}^{{P}^{2}}} + \frac{1 - \frac{{n}_{0}}{n}}{\frac{{n}_{0}}{n}} - 2 \frac{{\sum }_{0}^{PJ}}{\frac{{n}_{0}}{n} {μ}_{0}^{J} {μ}_{0}^{P}} - \frac{1 - \frac{{n}_{0}}{n}}{\frac{{n}_{0}}{n}} ) = \frac{1}{{n}_{0}} {( \frac{{μ}_{0}^{J}}{{μ}_{0}^{P}} )}^{2} ( \frac{{\sum }_{0}^{JJ}}{{μ}_{0}^{{J}^{2}}} + \frac{{\sum }_{0}^{PP}}{{μ}_{0}^{{P}^{2}}} - 2 \frac{{\sum }_{0}^{PJ}}{{μ}_{0}^{J} {μ}_{0}^{P}} )$$

In turn, estimation apparatus 204 may use the formula for the asymptotic estimate of variance 226 above with histograms 220 of metrics in partitions 218 to calculate the asymptotic estimate of variance 226. First, estimation apparatus 204 may aggregate histograms 220 from multiple partitions 218 into a single histogram (e.g., on a single machine) and calculate quantile 224 from the distribution of metrics in the aggregated histogram.

Next, estimation apparatus 204 may calculate the following statistics 222 from the aggregated histogram and/or individual histograms 220 on different partitions 218:

For each member:
P: total page load time (PLT) count
J: PLT count that is less or equal to the quantile
F: PLT count that lies in [quantile−delta, quantile+delta]

For each combination of test attributes and/or dimensions:
N: user count.
Sum(F): sum of F for all members.
Sum(P): sum of P for all members.
Sum(J): sum of J for all members.
Sum(P2): sum of P*P for all members.
Sum(J2): sum of J*J for all members.
Sum(PJ): sum of P*J for all members
   When statistics 222 are produced from individual histograms 220 in partitions 218, estimation apparatus 204 may subsequently aggregate (e.g., sum) statistics 222 from all histograms 220 into an overall set of statistics 222 for a set of metrics grouped under a given combination of test attributes 210 and/or dimensions 208.

Estimation apparatus 204 may then estimate variance 226 of quantile 224 using the following formulas:

Mean(J)=Sum(J)/N

Mean(P)=Sum(P)/N

Mean(PJ)=Sum(PJ)/N

Variance(J)=(Sum(J2)/N)−Mean(J)\hat{ }2

Variance(P)=(Sum(P2)/N)−Mean(P)\hat{ }2

Covariance(PJ)=Mean(PJ)−Mean(J)*Mean(P)

Variance(PJ)=Mean(J)\hat{ }2/Mean(P)\hat{ }2*(Var(J)/Mean(J)\hat{ }2+Var(P)/Mean(P)\hat{ }2−2*Cov(P)/Mean(J)/Mean(P))

Variance=Variance(PJ)/N)/(Sum(F)/2/delta)

In the above formulas, “delta” represents an interval around quantile 224 (e.g., a 50 ms window around a page load time quantile), and Sum(F)/2/delta is used to estimate the density of the metric around quantile 224.

Finally, testing apparatus 206 may generate and/or output a result 214 of A/B test 212 based on the estimated variance 226. For example, testing apparatus 206 may use variance 226 to calculate a p-value, margin of error, and/or other indicator of statistical significance in A/B test 212. Testing apparatus 206 may include the indicator in result 214, along with a difference (or lack of difference) in quantile 224 between the treatment and control variants of A/B test 212. Testing apparatus 206 may then output result 214 in a user interface, application-programming interface (API), notification, message, email, file, spreadsheet, database record, and/or other format.

By using simple calculations to accurately estimate the variance of a quantile metric, the system of FIG. 2 may allow large-scale A/B testing to be performed using quantile metrics. In contrast, conventional techniques for calculating quantile variances may include asymptotic estimates that inaccurately assume statistical independence of the corresponding metrics and/or less scalable bootstrap techniques that repeatedly sample from observed data and calculate variances from each resample. Consequently, the disclosed embodiments may improve computer systems and/or technologies for performing A/B testing, monitoring performance metrics, and/or estimating variances for quantile metrics.

Those skilled in the art will appreciate that the system of FIG. 2 may be implemented in a variety of ways. First, aggregation apparatus 202, estimation apparatus 204, testing apparatus 206, and/or data repository 134 may be provided by a single physical machine, multiple computer systems, one or more virtual machines, a grid, one or more databases, one or more filesystems, and/or a cloud computing system. Aggregation apparatus 202, estimation apparatus 204, and/or testing apparatus 206 may additionally be implemented together and/or separately by one or more hardware and/or software components and/or layers.

Second, the functionality of the system may be adapted to various types of online controlled experiments and/or hypothesis tests. For example, the system of FIG. 2 may be used to estimate quantile variances and/or perform A/B testing of quantile metrics for connections in an online network. The quantile metrics may include a 50^{th} percentile and 90^{th} percentile for the number of connections in the online network, or some other combination of percentiles and/or quantiles. In turn, the 50^{th} and 90^{th} percentiles may be used with A/B tests to determine if features and/or variants in the A/B tests increase connection growth across all users of the online network versus already well-connected users in the online network.

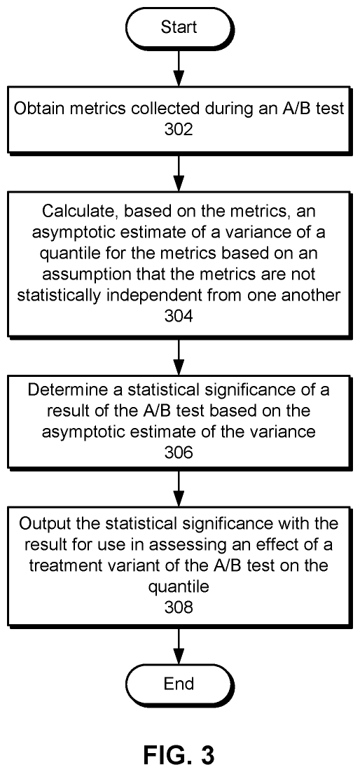

FIG. 3 shows a flowchart illustrating a process of performing A/B testing using quantile metrics in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, metrics collected during an A/B test are obtained (operation 302). For example, the metrics may be aggregated by a key such as a user identifier and dimensions such as user dimensions (e.g., country, language, industry, etc.) and/or product dimensions (e.g., product type, page ID, etc.). In turn, the aggregated metrics may include a histogram of the metrics for each treatment assignment in the A/B test and/or each user segment that is targeted using the A/B test.

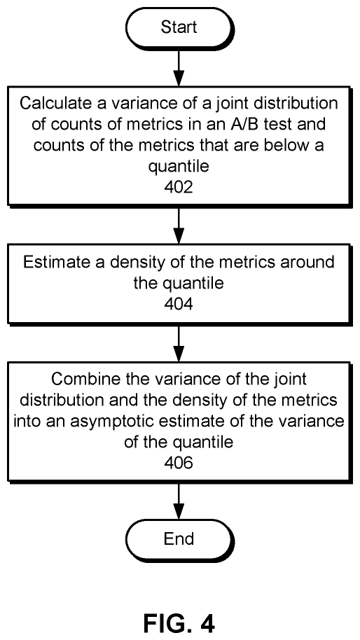

Next, an asymptotic estimate of a variance of a quantile for the metrics is calculated based on an assumption that the metrics are not statistically independent from one another (operation 304), as described in further detail below with respect to FIG. 4. The metrics may lack statistical independence within a certain grouping (e.g., metrics from the same user) and have statistical independence outside of the grouping (e.g., metrics from different users). Zero-valued metrics may also be excluded from calculation of the asymptotic estimate to reduce overhead associated with storing the metrics, aggregating the metrics into histograms, and/or using the metrics to produce the estimate.

A statistical significance of a result of the A/B test is then determined based on the asymptotic estimate of the variance (operation 306). For example, the estimate of the variance may be used to calculate a p-value, margin of error, and/or other indicator of statistical significance in the A/B test.

Finally, the statistical significance is outputted with the result for use in assessing an effect of a treatment variant of the A/B test on the quantile (operation 308). For example, the p-value, margin of error, and/or other indicator of statistical significance calculated from the variance may be included with corresponding values of the quantile for the treatment and control variants. In turn, the indicator may improve understanding of the impact of the treatment variant on the quantile.

FIG. 4 shows a flowchart illustrating a process of estimating a variance of a quantile in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

First, a variance of a joint distribution of counts of metrics in an A/B test and counts of the metrics that are below the quantile is calculated (operation 402). For example, the variance may be calculated from a first mean of the metrics, a second mean of the counts of the metrics that are below the quantile, and covariances associated with the joint distribution.

Next, a density of the metrics around the quantile is estimated (operation 404). For example, the density of the metrics around the quantile may be estimated based on an interval around the quantile.

The variance of the joint distribution and the density of the metrics are then combined into an asymptotic estimate of the variance of the quantile (operation 406). For example, the variance of the joint distribution may be divided by the density of the metrics and the number of users in the A/B test to obtain the asymptotic estimate of the variance of the quantile.

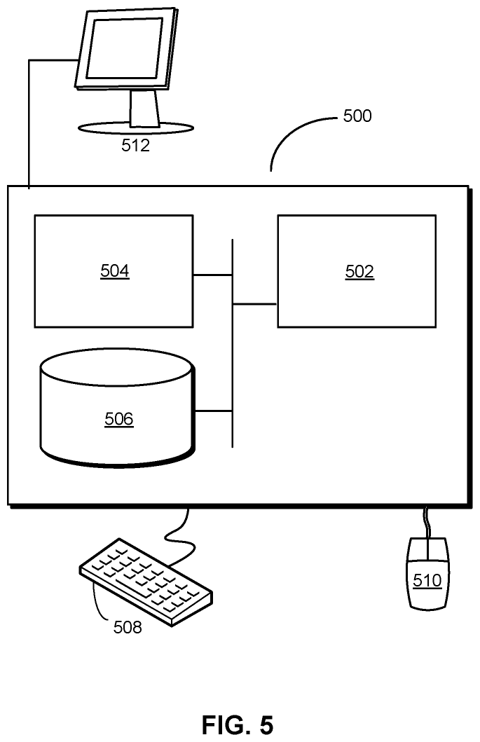

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the disclosed embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for performing A/B testing using quantile metrics. The system includes an aggregation apparatus, an estimation apparatus, and a testing apparatus, one or more of which may alternatively be termed or implemented as a module, mechanism, or other type of system component. The aggregation apparatus obtains metrics collected during an A/B test. Next, the estimation apparatus calculates an asymptotic estimate of a variance of a quantile for the metrics based on an assumption that the metrics are not statistically independent from one another. The testing apparatus then determines a statistical significance of a result of the A/B test based on the asymptotic estimate of the variance. Finally, the testing apparatus outputs the statistical significance with the result for use in assessing an effect of a treatment variant of the A/B test on the quantile.

In addition, one or more components of computer system 500 may be remotely located and connected to the other components over a network. Portions of the present embodiments (e.g., aggregation apparatus, estimation apparatus, testing apparatus, data repository, online network, etc.) may also be located on different nodes of a distributed system that implements the embodiments. For example, the present embodiments may be implemented using a cloud computing system that performs A/B testing of quantile metrics associated with a set of remote users.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining metrics collected during an A/B test;
calculating, by one or more computer systems, an asymptotic estimate of a variance of a quantile for the metrics based on a lack of statistical independence of the metrics from one another;
determining, by the one or more computer systems, a statistical significance of a result of the A/B test based on the asymptotic estimate of the variance; and
outputting the statistical significance with the result for use in assessing an effect of a treatment variant of the A/B test on the quantile.

2. The method of claim 1, wherein calculating the asymptotic estimate of the variance of the quantile based on the assumption that the metrics are not statistically independent from one another comprises:
calculating another variance of a joint distribution of counts of the metrics and counts of the metrics that are below the quantile;
estimating a density of the metrics around the quantile; and
combining the other variance and the density of the metrics into the asymptotic estimate of the variance of the quantile.

3. The method of claim 2, wherein calculating the other variance of the joint distribution of the counts of the metrics and the counts of the metrics that are below the quantile comprises:
calculating the other variance based on a first mean of the metrics, a second mean of the counts of the metrics that are below the quantile, and covariances associated with the joint distribution.

4. The method of claim 2, wherein estimating the density of the metrics around the quantile comprises:
estimating the density of the metrics around the quantile based on an interval around the quantile.

5. The method of claim 2, wherein combining the other variance and the density of the metrics into the asymptotic estimate of the variance of the quantile comprises:
dividing the other variance by the density of the metrics and a number of users in the A/B test to obtain the asymptotic estimate of the variance of the quantile.

6. The method of claim 1, wherein obtaining the metrics collected during the A/B test comprises:
aggregating the metrics by a key and one or more dimensions associated with the A/B test.

7. The method of claim 6, wherein:
the key comprises a user identifier, and
the one or more dimensions comprise at least one of a user dimension and a product dimension.

8. The method of claim 6, wherein aggregating the metrics by the key and one or more dimensions associated with the A/B test comprises:
generating a histogram of the metrics for a treatment assignment in the A/B test and a user segment that is targeted using the A/B test.

9. The method of claim 1, wherein determining the statistical significance of the result of the A/B test based on the asymptotic estimate of the variance comprises:
calculating an indicator of the statistical significance from the asymptotic estimate of the variance.

10. The method of claim 9, wherein the indicator comprises at least one of:
a p-value; and
a margin of error.

11. The method of claim 1, wherein a first subset of the metrics from a user lacks the statistical independence and a second subset of the metrics from different users includes the statistical independence.

12. The method of claim 1, wherein the metrics comprise a page load time.

13. A system, comprising:
one or more processors; and
memory storing instructions that, when executed by the one or more processors, cause the system to:
obtain metrics collected during an A/B test;
calculate an asymptotic estimate of a variance of a quantile for the metrics based on a lack of statistical independence of the metrics from one another;
determine a statistical significance of a result of the A/B test based on the asymptotic estimate of the variance; and
output the statistical significance with the result for use in assessing an effect of a treatment variant of the A/B test on the quantile.

14. The system of claim 13, wherein calculating the asymptotic estimate of the variance of the quantile based on the assumption that the metrics are not statistically independent from one another comprises:
calculating another variance of a joint distribution of counts of the metrics and counts of the metrics that are below the quantile;
estimating a density of the metrics around the quantile; and
combining the other variance and the density of the metrics into the asymptotic estimate of the variance of the quantile.

15. The system of claim 14, wherein calculating the other variance of the joint distribution of the counts of the metrics and the counts of the metrics that are below the quantile comprises:
calculating the other variance based on a first mean of the metrics, a second mean of the counts of the metrics that are below the quantile, and covariances associated with the joint distribution.

16. The system of claim 14, wherein combining the other variance and the density of the metrics into the asymptotic estimate of the variance of the quantile comprises:
dividing the other variance by the density of the metrics and a number of users in the A/B test to obtain the asymptotic estimate of the variance of the quantile.

17. The system of claim 13, wherein calculating the asymptotic estimate of the variance of the quantile based on the assumption that the metrics are not statistically independent from one another comprises:
omitting zero-valued metrics from calculation of the asymptotic estimate of the variance.

18. The system of claim 13, wherein obtaining the metrics collected during the A/B test comprises:
aggregating the metrics by a key and one or more dimensions associated with the A/B test.

19. The system of claim 18, wherein aggregating the metrics by the key and one or more dimensions associated with the A/B test comprises:
generating a histogram of the metrics for a treatment assignment in the A/B test and a user segment that is targeted using the A/B test.

20. A non-transitory computer-readable storage medium storing instructions that when executed by a computer cause the computer to perform a method, the method comprising:
obtaining metrics collected during an A/B test;
calculating an asymptotic estimate of a variance of a quantile for the metrics based on a lack of statistical independence of the metrics from one another,
determining a statistical significance of a result of the A/B test based on the asymptotic estimate of the variance; and
outputting the statistical significance with the result for use in assessing an effect of a treatment variant of the A/B test on the quantile.
